(19) United States
(12) Patent Application Publication
(10) Pub. No.: US 2018/0232791 A1
(43) Pub. Date: Aug. 16, 2018

(54) SYSTEM AND METHOD FOR GUIDING USERS TO CHOOSE AND CONNECT TO BUSINESSES

(71) Applicant: Ketan Shah, (US)

(72) Inventor: Ketan Shah, Fremont, CA (US)

(21) Appl. No.: 15/897,156

(22) Filed: Feb. 15, 2018

Related U.S. Application Data
(60) Provisional application No. 62/459,547, filed on Feb. 15, 2017.

(51) Int. Cl. G06Q 30/06; G06F 17/30; G06N 99/00

(52) U.S. Cl. CPC G06Q 30/0617; G06F 3/04842; G06N 99/005; G06F 17/30867

(57) ABSTRACT

Embodiments herein provide a method and system provide a method and system for guiding users to choose and connect to business and services based on existing search results. The method includes providing a customised list of most suitable/relevant services to the user. Further, the method includes enabling search engines, directories and advertising agencies with guiding user behaviour and connect the user to specific local service to maximise revenue and other benefits as well as better targeting for businesses.

This application claims the benefit of U.S. Provisional Application No. 62/459,547, filed Feb. 15, 2017.

### TECHNICAL FIELD

Embodiments herein relate, in general, to system and method for a guiding and connecting to the right product or service, and, more particularly, to a system and method for assisting and guiding a user using data processing device to choose and connect to a provider.

### BACKGROUND

Internet is being increasingly used to relay information, advertise, and engage in e-commerce. With the increase in number of users exploring the one or more sources via Internet, the data/information fetched related to the one or more sources is also increased. For example, the user performs a search-based query, through one or more search engines, in order to identify the services or the product in which the user is interested, the service such as “local dentist for specific dental needs or information on dental services”. Thus, a list of search result links are shown consisting of links related to local dentists for specific needs, dental information for specific need or links that list of local dentists shown related to the local dentist for specific dental needs.

The search terms provided by the user are typically mapped (or matched) with the terms of the service provider (dentists) found on a source like the web page of the dentist or on web pages of other resources who have information about dentists (e.g. yellow pages or directory of dentists, or insurance directory). And, if matching or mapping is not close enough, many of the search results provided (by the one or more search engines) may be irrelevant to the user.

Even in cases, where the search terms map properly to search results and relevant results are found, the user needs to go through a process of decision making in order to select one or more dentists that suits his needs. Such a process may involve the user navigating to each site and finding out information about the provider to be able to identify potential providers that the user may ultimately use. Post filtering, user must contact the providers for validating/vetting the provider, and for checking availability of the providers according to his/her schedule.

For example, if the user is interested to visit the local dentist on a particular day/particular time or a specific treatment (in which, the dentist may or may not specialise in), the user may have to navigate the search result page, find relevant links related to local dentists, visit their web pages or call them to find their availability and to book an appointment and so on. And, further, when the user is interested in finding an appointment for a dentist today within 5 miles radius of his/her residence, post navigating within the search results of individual dentist or dental directories, user may find that either the dentist is not available today or the dentist is not within distance of 5 miles. This often results in waste of time in selecting the dentist that meets users' needs.

Thus, it is desirable to have options and methods that simplify and improve efficiencies in the process of choosing and connecting to the right business. Such methods can also give some control to web page owners or advertising companies to guide the users in the selection process.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1 is a block diagram illustrating the overall system, according to embodiments disclosed herein;

FIG. 2 is a block diagram illustrating a detailed view of the central server illustrated in FIG. 1, according to embodiments disclosed herein;

FIG. 3 is an illustration of the database as illustrated in FIG. 2, depicting the different data that it can store, according to embodiments disclosed herein;

FIG. 4 illustrates various units of a mobile device, according to embodiments as disclosed herein;

FIG. 5 is a flow diagram illustrating a method for providing an assisted and guided search, according to embodiments as disclosed herein;

FIG. 6 is an example in which one or more operations of a guiding unit, according to embodiments as disclosed herein; and

FIG. 7 illustrates a block diagram illustrating the interactions between various components, according to embodiments as disclosed herein.

### DETAILED DESCRIPTION OF INVENTION

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, micro-controllers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Embodiments herein disclose a computerized system and methods for guiding a user in choosing a service on a personal device.

The system allows providers (for example, service providers) to publish their information on the system. Further, the system also fetches publicly available information about the providers to correlate and update the information in the system.

The system enables a guiding unit, which upon identifying a user need for connecting with businesses, engages with user by asking one or more questions, and receives answers from the user; identifies list of services for the user to potentially connect with; takes the help of a central server to identify list of services for the user to potentially connect with, where the list of services is identified based on matching provider information available, business rules and user history; receives user confirmation to connect with a specified service; and initiates an interactive session between the user and the specified service, to enable the user to connect with the service.

In various embodiments, the user need can be identified by way of identifying an action from user in the form of a textual search request, a voice input request, or a voice input through a phone call (for example, interacting with an IVR system on the phone).

The guiding unit can be a widget that can be integrated with any web page. In a preferred embodiment, the widget is embedded in a search page on a search site or on a business directory site. However, in other embodiments, the widget itself can be a web service with a dedicated web page or another suitable interface.

In various embodiments, the guiding unit can be a widget embedded in a third-party search engine; a widget embedded in a third-party directory; a widget embedded in a webpage; a widget embedded in a web application; a widget embedded in a mobile application; and a widget connected to a phone system.

In various embodiments, the guiding unit may ask one or more follow-up questions after receiving request to refine request and provide better search results. The questions may be based on at least industry specific knowledge (for example, relevant training data related to the category or topic identified), details of the services offered by available service providers at the moment and users answers to previous questions. As an example, the list of categories where training can be done can include but not limited to Medical, Dental, Home improvement, Beauty and hair salon, Tutors etc.

In various embodiments, the system allows for filtering and prioritizing (or shortlisting) before presenting to user on a user interface. The filtering and prioritization may be done based on pre-defined rules specific to industry or business (for example, if user is looking for a dentist for a tooth ache, information relating to practices focusing on cosmetic dentists and orthodontists may be removed before presenting to user), intelligence gathered from request and subsequent questions asked to users (for example, if user is looking for a dentist for a tooth ache for his son, asking user age of his/her son and matching with right pediatric dentist); previous history of similar search requests by the same user, users with similar profile or other users and patterns in final selection; user session cookies; recent interactions on the personal device by the user (for example, if user has looked for teenage shoes and if the user asks for dentist for tooth ache for his son, deriving the information that user may have teen age son and he may not need pediatric dentist and thus not excluding regular family dentists from the results); the number of leads pending to be served for relevant business services (for example, between two dentists with similar services and reviews, if one has received multiple leads, giving another dentist a preference); average review ratings for business services; rate of booking appointments (for example, giving preference to a dentist who has more openings for new appointments); active promotions for relevant businesses; geography of business services by matching consumers location proximity to a business's proximity if other conditions also match; availability of business services at the time of request; and availability of business services when the service is needed.

In various embodiments, the system may use a pre-configured list of search engines and directory services to find relevant providers in addition to system's database of published providers.

In various embodiments, activating said guiding unit interface is done using one mechanism from the group of: activating manually by the user by interacting with a visible artifact on a web page; and activating automatically by the guiding unit, based on pre-defined rules. Prior to activation of the interface, the guiding unit may be visible in the form of an artifact including but not limited to a page link; a visible interactive widget on the web page; and an invisible interactive widget activated by a voice command.

In various embodiments, the rule used for activating the guiding unit interface can be but not limited to time elapsed since the time user landed on the interface; detecting access of specific information on the interface; and detecting an intent of user to access pre-defined type of information.

In various embodiments, the interactive session initiated by the guiding unit can be but not limited to a voice call session; a chat session with a support member of the service; and a chat session with a chat-bot.

In various embodiments, the guiding unit may assist the user in performing one or more tasks through the interactive session. The tasks can be but not limited to scheduling an appointment; finding information about open hours; and finding availability of a specific service.

In various embodiments, the system allows for collecting data to train the guiding unit for improved guidance. For example, from previous searches for “local dentist for tooth ache”, it may be that majority of users asked for appointment with in 3 days. Learning from this data set, the system can deprioritize dentists who may not have appointment in next three days for subsequent searches of similar nature.

Embodiments herein also enable guiding a user in choosing a service on a personal device. In various embodiments, the guiding unit on the personal device interacts with a central server to fetch relevant information as the unit interacts with the user.

The various embodiments are explained hereunder using example embodiments illustrated in figures.

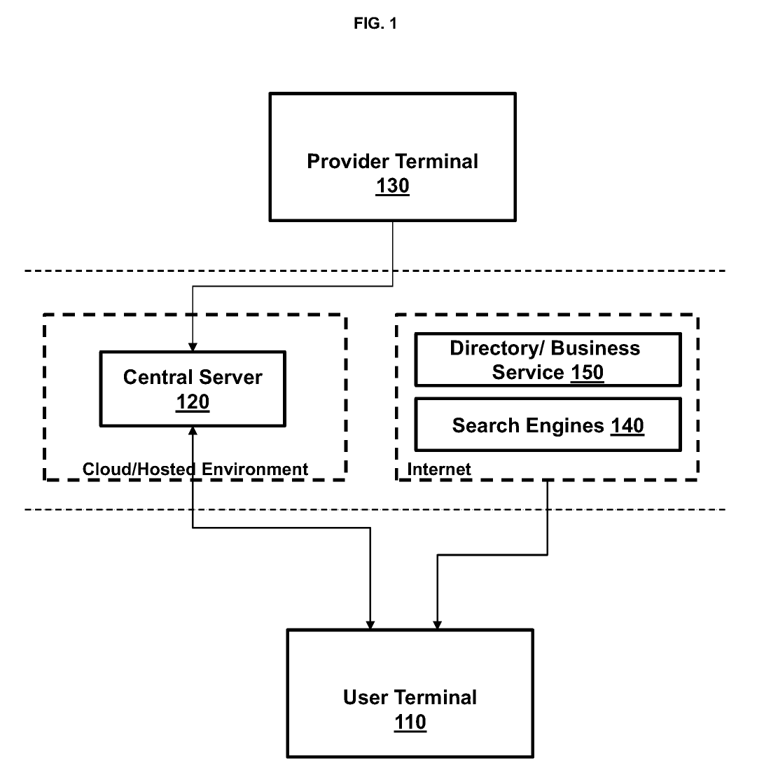

FIG. 1 is a block diagram illustrating the overall system, according to an embodiment. The system includes a user terminal 110 operated by a user, a central server 120 that at least has necessary training models, and processing logic to operate on data to respond to user needs, a provider terminal 130 for businesses to operate on to feed necessary information and manage their presence in the system, and a set of Internet sites (140 and 150) with which user terminal interacts to obtain information about businesses that the user may be potentially looking for.

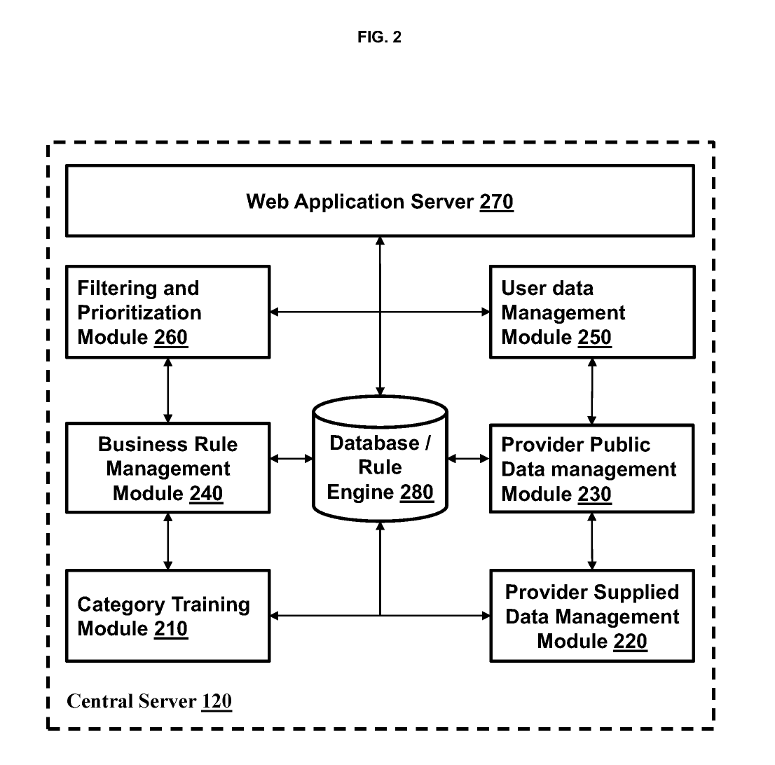

FIG. 2 is a block diagram illustrating a detailed view of the central server 120. In an example embodiment as illustrated in FIG. 2, the central server includes various modules as described hereunder:

The category training module provides interface and management tools to collect industry specific data and create rules based on the data. For example, this module is responsible for gathering data about a category of service providers like pediatric dentists and can collect information such as age of the patients that are typically managed by such dentists. Such information helps in defining the category and also any rules relating to the category that may be applied at the time of figuring out the right service provider for a user's need. For example, if a user is looking for a dentist service for a child, the system recognizes with the help of the information and rules captured by this module that a pediatric dentist may be appropriate for the service the user is looking for. In another example, rules may be included to understand severity of a problem for which a user is looking for a service, to assist in finding services based on associated urgency. For example, “teeth whitening” is less serious than “root canal”. And, therefore, based on severity of condition, rules may be added to prioritize those services that have on call doctors offering such services. Furthermore, rules can be relating to choosing or prioritizing those providers that have specific services mentioned in reviews even though overall review may be lower compared to other service providers. For example, a dentist may have less overall rating than other dentists in a list, but the dentist may have one good review for exact service a user is looking for and it is possible that there are not many alternatives for the user's requirements at that point in time when user needs it.

The provide data management module 220 is responsible for gathering and managing provider data that is to be presented to users as and when required. The information gathered and managed includes the nature of business of the providers, the details of the products and/or services, the hours of operations, contact information, information about team, best modes of communication, exceptions for generic information like hours (for example, holidays, events during which they may have reduced or different hours of operation). The information collected may also include domain specific information such as insurance information for doctors (for example, dentists). The domain specific information for dentists may include the different insurance providers they accept, doctor profiles with more detailed information about practice specialties, the various aspects of practice that they cover, any industry recognition specific to that domain, and so on.

In various embodiments, the provide data management module 220 may poll provider systems (through private APIs and other suitable means) on a regular basis to update the information. Further, providers may also update their information through an interface provided by the web application hosted by the web application server 270.

The provider public data management module 230 is responsible for collection of data from publicly available sources. The information collected can include information from providers public forums like websites, social media sites, and any other relevant sources. The information collected may also include online reviews for provider's product or service. The system may use information about business and services collected to update any stale information available within in the system. Further, the system can use the public reviews information to present the providers in appropriate order when presenting to users. In an example embodiment, the system may use only reviews as a basis for calculating an internal rating and present various matching providers in order of rating.

The business rule management module 240 is responsible for enabling creation of preferences and rules by directories or businesses that host the guidance unit on their website. For example, a directory service hosting the guidance unit on their website can create rule such as this: one in 3 providers listed in a final list created by the guiding unit should be a paid advertiser if it matches users' preference. The system may also allow businesses or directory owners to create more specific preference rules such as highlighting certain sponsoring businesses in a pre-defined manner. In some embodiments, the highlighting may happen in terms of placement of the provider's information or by way of color highlighting.

The user data management module 250 is responsible for managing user interaction, preferences, history and other user specific data. The module records information about user through the various interactions including user requests over a period of time, answers to certain questions during interaction with guiding unit, user cookies and inferences from interactions, and so on. Using information from previous interactions, the user data management module can provide guiding units with contextual information about users so that guidance unit can provide more relevant results. For example, inferring that user may have teenage kids from certain data set and creating certain flags to be used by guiding unit not to show only pediatric dentist when user searches for “tooth ache for kids”.

The filtering and prioritization module 260 is responsible for prioritization of various providers before presenting to a user, based on user needs. The filtering and prioritization involves taking into account at least matching provider information, the various preferences and rules created by the directory or business service where the guiding unit is operating, the category training information, the user preferences based on user profile information available in the system (through user history and interactions). In an embodiment, filtering can be based on matching information, and further prioritization (or shortlisting) can be based on other information such as rules and user profile information.

In various embodiments, the filtering and prioritization can also be based on user selection and input data. For example, for dentist category, information such as the following can be used to prioritize results in a given geography or period of day:

number of users asked for immediate appointment for teeth whitening although it's not an emergency,

number of users who were ok seeing family dentist for cosmetic treatment and did not insist on seeing a cosmetic dentist, and

number of users who selected dentist beyond 5 miles radius.

The web application server 270 hosts one or more web applications to provide necessary user interface and application program interfaces for users, providers and businesses to interact with the system.

In an embodiments, providers and businesses may interact with the system through a web user interface served by a web application running in the web application server 270. The user interface enables providers, and businesses to consume information and also enter necessary information including but not limited to provider information, business rules, preferences and so on.

In various embodiments, providers and businesses may also consume information from the system through application program interfaces (for example, via HTTP).

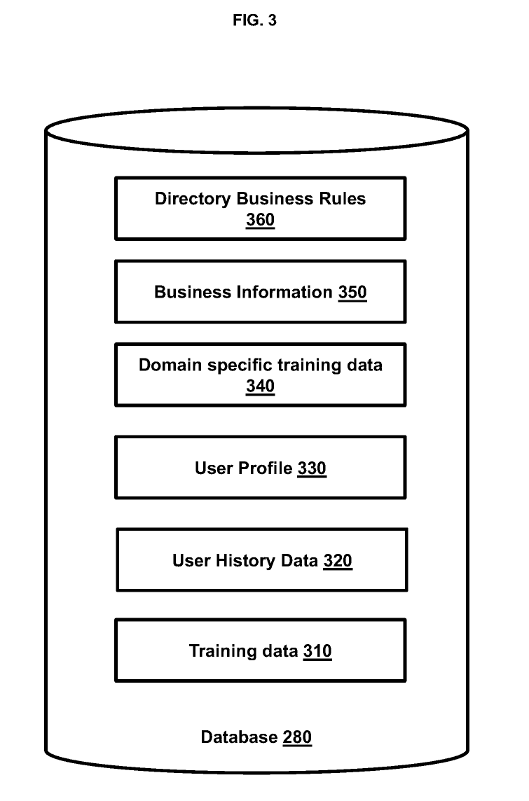

FIG. 3 is an illustration of the database 280, depicting the different data that it can store. In an embodiment, the database can store category training data 310, user history data 320, user profile data 330, domain specific training data 340, business information about providers 350, and directory business rules 360.

Examples for nature of data stored in database are provided hereunder:

Directory business rules:
One in three search results should be a paid advertiser it matches users' preference, Advertisers who received lowest number of leads should get higher priority if it matches users' preference
   Business information:
Time sensitive information in addition to publicly available information. For example, Daily promotions, Availability of appointments and durations, last min specials, change in business hours, inventory updates
   Domain specific training data:
For example, for dentistry domain training data could be
   Top 100 questions asked when a patient calls a dentist
   Percentage of people want cosmetic dentist vs family dentist for teeth whitening
   Average age of a child when parents stop looking for pediatric dentist
   Average time of appointment given to patient for various treatments
      User profile:
Non-private data such as demographics, geo location, data stored in cookie, age range, sex, high level family data like marital status, has children etc.
   User history data:
Past history of searches, past selection of other providers, questions answered in past
   Training data:
New category specific information, Users answers to specific questions, User's rejection of suggested providers, user selection patterns

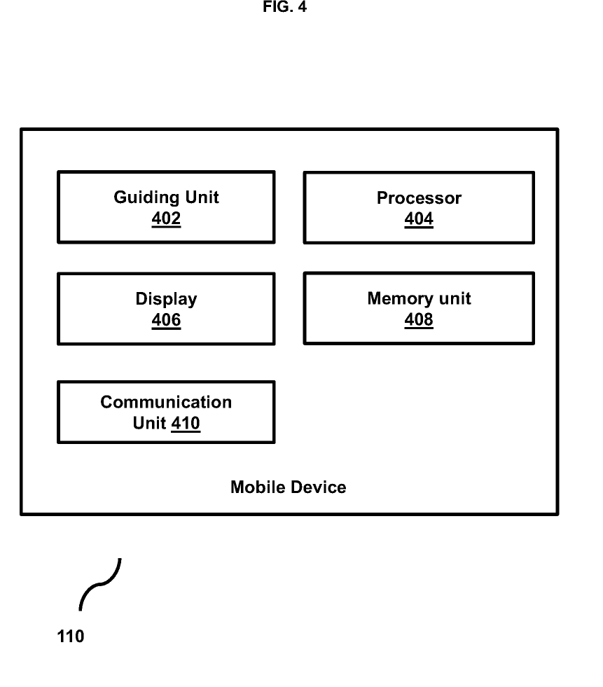

FIG. 4 illustrates various units of a mobile device as an example user terminal, according to embodiments as disclosed herein. The mobile device may be, for example, a smart phone, a laptop computer, a smart display, a notebook computer, a notebook, a tablet, wearable device, Internet of things (IoT) devices, or any consumer electronic devices. Other forms of data processing device are within the scope of the exemplary embodiments discussed herein.

The mobile device includes a guiding unit (402), a processor (404) (for example; a hardware unit, an apparatus, a Central Processing Unit (CPU), a Graphics Processing Unit (GPU)) communicatively coupled to a memory unit (408) (e.g., a volatile memory and/or a non-volatile memory), a display (406) (e.g., a Cathode Ray Tube (CRT) display, a Liquid Crystal Display (LCD)), a Light-emitting diode (LED) being interfaced with the processor, and a communication unit (410).

Further, the mobile device may include a search engine (i.e., search engine client) for aiding the user to explore one or more products/services. The search engine can be a text or voice-based search engine including but not limited to voice-based assisting services.

The guiding unit (402) can be configured to interact with the user based on one or more attributes. The attributes can be, for e.g., rules, intelligence it gathers from the search query, history of data on the website/search engine, user cookies, other data gathered by the system from various sources.

The guiding unit (402) can be configured to be activated automatically upon identifying user action on the device such as searching for a local business on the phone using a search engine application or on a search engine using the browser on the device or any other software application. The search engine can include popular search engines such as GOOGLE, YAHOO, BING and so on. Further, search engines can also include business directories such as YELLOW PAGES (YP.com), and advertising agencies who market on behalf of service providers. The guiding unit (402) may be triggered automatically when the user on the device accesses relevant information either using a native application on the device or using web browser on the device or a voice-based assistant like SIRI by APPLE or ALEXA by AMAZON. The guiding unit (402) can interact using text or voice commands.

In various embodiments, the guiding unit (402) can be part of a specific application or part of a specific website. When the guiding unit (402) is hosted by an application or website (example, a business offering a service, or a directory service), the guiding unit can be configured to include one or more rule/policies providing levers for the owner (i.e., service provider, product owner) of the webpage to guide the user behaviour and connect the users to specific local business. For example, a directory service like YELLOW PAGES (YP.com) can trigger the guiding agent when a user searches for businesses. From there on, the guiding unit (402) can present the user with a series of questions to help the user make the right choice. Subsequently, the guiding unit (402) can even connect the user with the selected business or service to potentially setup an appointment (for example, dentist appointment) or to obtain more information about the business's product or service.

In various embodiments, the guiding unit may continue helping the user in the background till the user disengages the unit. The guiding unit derives or infers information from initial search query, cookies, past queries, interactions and other sources and continues learning about the user preferences. Thus, it minimizes the questions it needs to ask the user in order to connect him with appropriate business.

Further, the guiding unit (402) can be configured to receive one or more inputs during the guidance process. The inputs can include, for e.g., text input, voice input, etc.

In various embodiments, the guiding unit can be automatically trained and improved based on the user recent experiences.

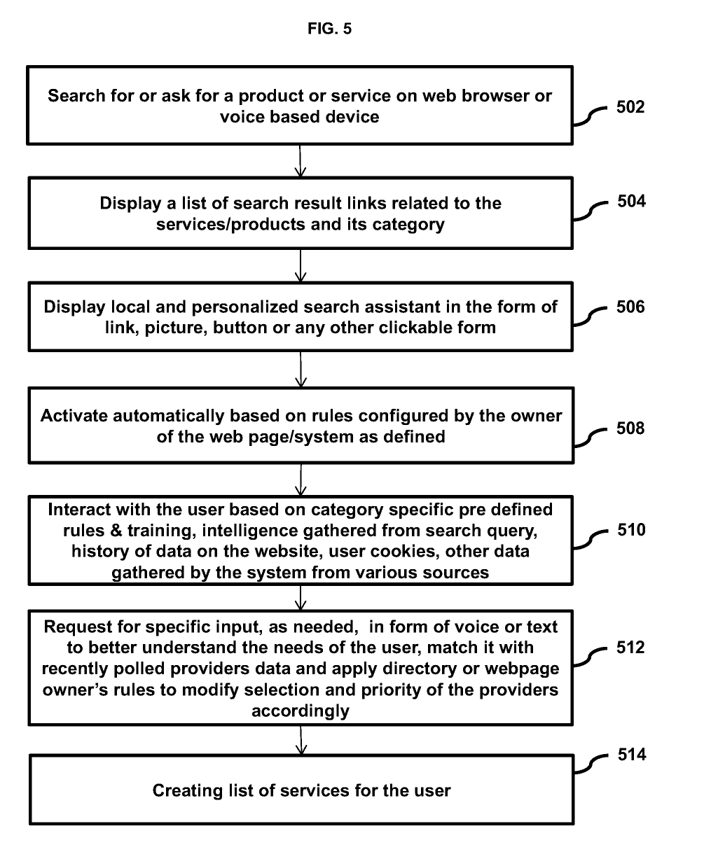

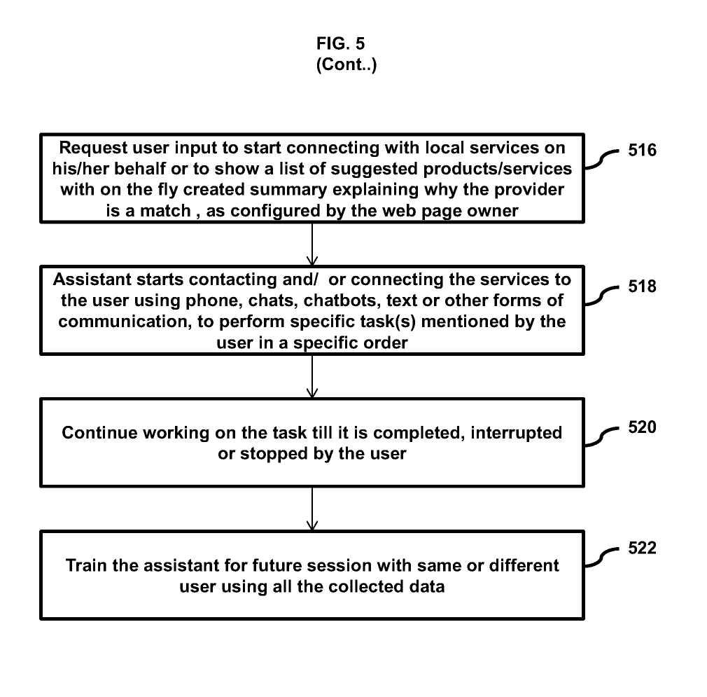

FIG. 5 is a flow diagram illustrating a method for providing guidance to choose and according to embodiments as disclosed herein.

Referring to the FIG. 5, at step 502, the method includes searching for a product/service. For example, referring to the mobile device as shown in the FIG. 4; the guiding unit, including one or more search engines, can be configured to search for a product/service based on the search terms/strings provided by the user.

At step 504, the method includes displaying a list of search result links related to the services/products and its category. For example, referring to the mobile device as shown in the FIG. 4; the display coupled to the guiding unit can be configured to display the list of search result links related to the services/products and its category.

At step 506, the method includes displaying a local and personalised guide (i.e., guiding unit). The guiding unit can be displayed in the form of, for e.g., a link, picture, button or any other clickable form or a voice activated listening agent or form. For example, referring to the mobile device as shown in the FIG. 4; the display can be configured to display the local and personalised guide (i.e., guiding unit). The guiding unit may be trained in one or more categories the user has expressed interest in. The user interest can be inferred from the user's activities on the phone, including but not limited to searching for a business or service using search engines, business directories, and accessing services and information about services through other means on the mobile device such as using chat-bots and so on.

In various embodiments, the guiding unit (402) on the mobile device may connect to an external server to download information about businesses and services for one or more categories based on changes in user interests. For example, if a user starts looking for physical therapy services for the first time, and if the guiding unit (402) is not trained in the category, the guiding unit (402) may connect to an external server to fetch generic training information concerning the category of physical therapy services, depending on the permissions provided by the user, to be able to potentially guide the user with choosing and connecting to physical therapy services when required by the user. Depending on user preferences, the guiding unit (402) can also update an external server with generic training information (without exposing specific information) to aid users with similar profiles.

At step 508, the method includes activating, the guiding unit, automatically based on rules configured by the owner of the web page/system defined. For example, referring to the mobile device as shown in the FIG. 4; the processor can be configured to activate the guiding unit automatically based on the rules configured by the owner of the web page/system defined.

At step 510, the method includes interacting with the user based on the rules, intelligence it gathers from the search query, history of data on the website, user cookies, other data gathered by the system from various sources. For example, referring to the mobile device as shown in the FIG. 4; the guiding unit can be configured to interact with the user based on the rules, intelligence it gathers from the search query, history of data on the website, user cookies, other data gathered by the system from various sources.

At step 512, the method includes requesting for specific input, as needed and modifying the user behaviour accordingly. For example, referring to the mobile device as shown in the FIG. 4; the guiding unit can be configured to request for the specific input, as needed and modifying the user behaviour accordingly.

At step 514, the method includes creating a list of services to the user, based on combination of rules, combination of logics and users input. For example, referring to the mobile device as shown in the FIG. 4; the guiding unit can be configured to create the list of services to the user, based on combination of rules, combination of logics and users input. For example if 10 businesses match user's preference, the guiding unit can decide whom to include in the list and promote based on, for examples, combination of following data:

Which business has received how many leads in a specific period

Average rating and reviews

Rate of booking appointments

The guiding unit can be configured to a logic using such data to determine a specific display sequence and the frequency of promotion for each business. The unit could promote a business who is running a promotion or it could promote a business who does not have a promotion but is the best rated with highest no. of reviews.

At step 516, the method includes requesting the user input to start connecting with local services on his/her behalf or would like to see a list of suggested products/services with a summary i.e., summary forms are configurable by the web page owner. For example, referring to the mobile device as shown in the FIG. 4; the guiding unit can be configured to request the user input to start connecting with local services on his/her behalf or would like to see a list of suggested products/services with a summary i.e., summary forms are configurable by the web page owner.

At step 518, the method includes, if selected, the guiding unit can be configured to start contacting and/or connecting the services to the user using phone, chats, chat-bots, text or other forms of communication, to perform a specific task(s) mentioned by the user. For example, referring to the mobile device as shown in the FIG. 1; the guiding unit can be configured to start contacting and/or connecting the services to the user using phone, chats, chat-bots, text or other forms of communication, to perform a specific task(s) mentioned by the user.

At step 520, the method includes, continue working on the task till it is completed, interrupted or stopped by the user. The task could be performed in the background. For example, referring to the mobile device as shown in the FIG. 4; the guiding unit can be configured to work, continuously, on the task till it is completed, interrupted or stopped by the user. The task could be performed in the background.

At step 522, the method includes collecting all the data and used to train the guiding unit (402) for future session with same or different user. For example, referring to the mobile device as shown in the FIG. 4; the guiding unit can be configured to collect all the data and used to train the guiding unit (402) for future session with same or different user.

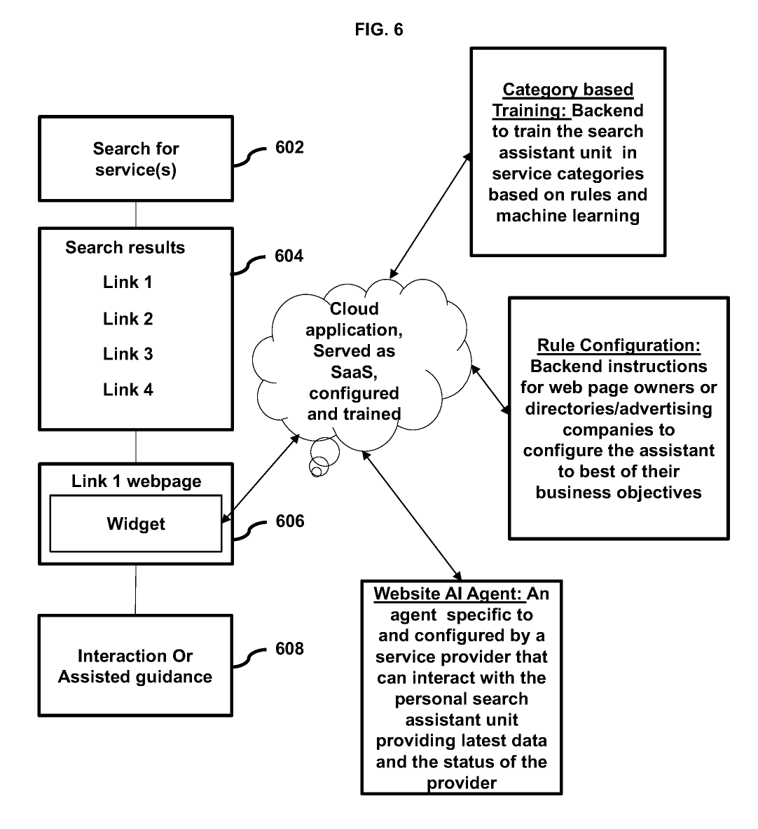

FIG. 6 illustrates an example in which one or more operations of a guiding unit, according to embodiments as disclosed herein.

Referring to the FIG. 6, at first the processor of user terminal can be configured to process the search (602) term provided by the user, where the search term is related to services/products. Further, the display, coupled to the processor, may result in displaying (604) one or more links related to the services/products based on the search term processed by the processor. The link may be modified to include floating or embedded interaction space for the guiding unit to interact with the consumer/user to connect the user with most suitable service based on their needs.

Further, the mobile device can activate the guiding unit (widget in 606), the activation can be system defined/manual. The activation includes for e.g., Auto activation—once clicked on a relevant web page, Time delayed activation after user lands on a web page, Action based activation (Click or voice command), and services rule based activation. The services rule based activation includes, for e.g., providing priority to advertisers who has not received enough leads, priority to advertisers who are highly rated in the area, priority to advertisers who has open appointments in next 3 hours, Continuously calculate region of interest (ROI) and try to meet the desired ROI for each advertiser and train the guide accordingly, Mix and match advertisers list to show based on combination of requirements. Example include x % of service provider who are not advertisers. Give them leads to be used by target (e.g., sales) to convert them into advertiser, Rules are in general based on target goals, advertisers ROIs, consumers proximity, rating of advertisers, availability of the service providers, relevance of services provided and what a consumer is looking for.

Example of at least one conversation (to demonstrate the ability of the agent to ask guided questions) to aid (608) in the decision making process: A consumer is looking for “top rated dentist for kids in Fremont (Calif.). Consumer lands on “yellowpages.com” listing page. A guiding unit (402) is activated based on rules.

In another example, Following conversation may take place via text or voice: Guiding unit: “Hello, May I assist connecting you with a dentist that matches your need?”
User: “Yes”
Guiding unit: “Are you looking for an appointment today?”
User: “Yes”
Guiding unit: How old is the child?
User: 13 years old
Guiding unit: “OK. Please give me a moment”
Guiding unit: “I have found 5 dentist that are highly rated, within 5 miles radius of Fremont downtown, who may be able to see you today. I have also included family dentists who see young patients and excluded some paediatric dentists who see younger kids. Following is the list. Would you like me to connect you with the dentists?
User: “Yes”
Guiding unit starts an audio or chat base facilitated communication session. Connects with first dentist in the list and facilitates direct conversation between the dental office and the consumer. In various embodiments, the guiding unit (402) may allow the user to change or control the sequence of communication with the dentists and allow users to select an order in which he wants to connect to the selected dentists. At the end of the session guiding unit (402) asks the user if he/she would like to get connected to another dentist in the list, and the mode of communication (example, text or audio). User can select the communication channel. The user preferences may be stored and used for further training of the guiding unit (402).

Further, the training process may include following: Industry data on how people select a product or service in a category. How to account for service rules without compromising consumer's preferences for the service he/she is looking for. Service rules would be based on target goals, advertisers ROI (Return on Investment), consumer's proximity, rating of advertisers, availability of the service providers, and relevance of services provided and what a consumer is looking for. Patterns on past interactions with the same or any other users in the same geography and/or category. How to filter services based on consumer/user preference. How to infer to a set of data based on consumers answers in the conversation to minimise the questions asked by the guiding unit (402).

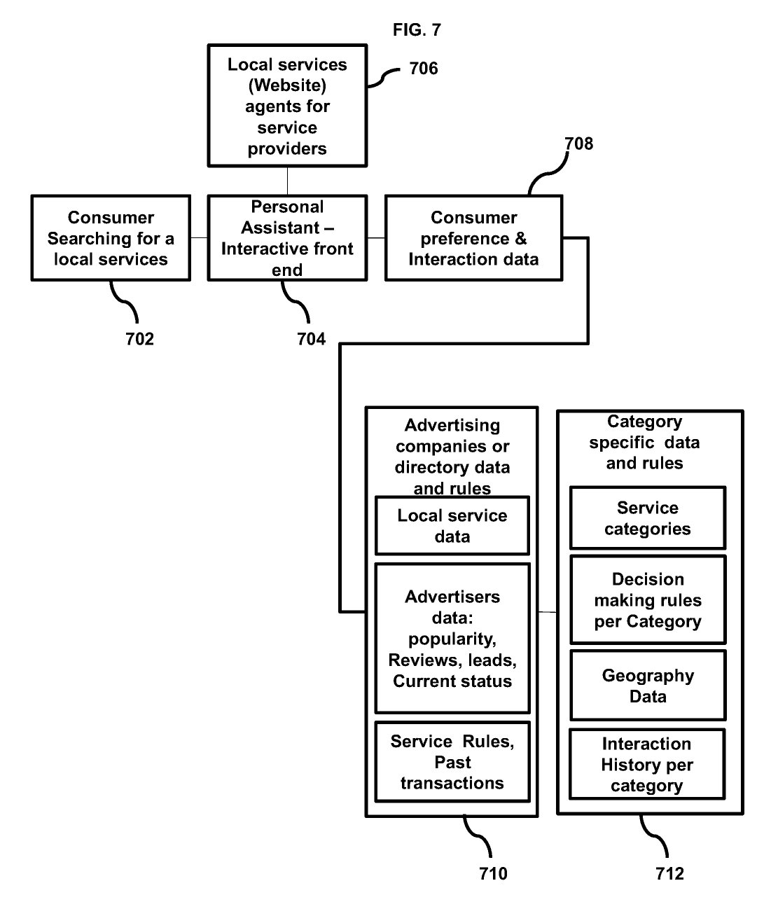

FIG. 7 illustrates a block diagram illustrating the interactions between various components, according to embodiments as disclosed herein.

Referring to the FIG. 7, once the consumer starts searching (702) for local services (for e.g., dentists), the local service agents (704) (website) may display plurality of links associated therewith. The guiding unit (704) (when activated) can be configured to provide Personal Assistant like interactive front end features to the user of the webpage. The guiding unit can be configured to extract the consumer preference & interaction data (708) from the one or more attributes of the user. The one or more attributes such as for e.g., rules, intelligence it gathers from the search query, history of data on the website/search engine, user cookies, other data gathered by the system from various sources. The guiding unit can be further configured to provide the relevant service, as required by the user/user interested service based on, for e.g., Service Rules, past transactions, Advertisers data: popularity, Reviews, leads, Current status, and Local service data (710). Further, the guiding unit can be configured to categorise the result based on, for e.g., Service Categories, Decision making rules per Category, Geography Data, and Interaction History per category (712).

Accordingly, embodiments herein allow reducing the effort involved in choosing and connecting to a business/service. Further, they allow search engine provides, business directories, and advertising agencies to maximise revenue and offer better targeting to businesses listing their businesses on their platforms.

The embodiments disclosed herein can be implemented through at least one software program running on at least one hardware device and performing network management functions to control the elements. The elements shown in the FIGS. 1 to 7 include blocks, elements, actions, acts, steps, or the like which can be at least one of a hardware device, or a combination of hardware device and software module

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A computerized method for guiding a user in choosing a service on a personal device, the method comprising:
identifying user action, by a guiding unit, indicating a user need for connecting with businesses;
activating a personalized interactive interface of the guiding unit to help user select a service provider;
engaging with user, by a guiding unit, by asking one or more questions by the agent, and receiving answers from the user;
identifying, by the guiding unit, list of services for the user to potentially connect with;
filtering and shortlisting, by a filtering and prioritization module, said list of services, when requested by the guiding unit to identify list of services for the user to potentially connect with, wherein the list of services is identified based on matching provider information available, business rules and user history;
receiving, by the guiding unit, user confirmation to connect with a specified service; and
initiating, by the guiding unit, an interactive session between the user and the specified service, to enable the user to connect with the service.

2. The method in claim 1, where said interface is one among:
a widget embedded in a third-party search engine;
a widget embedded in a third-party directory;
a widget embedded in a webpage;
a widget embedded in a web application;
a widget embedded in a mobile application; and
a widget connected to a phone system.

3. The method in claim 1, where said user action is one among:
textual search request;
voice input request; and
voice input through a phone call.

4. The method in claim 1, where said method further comprising:
guiding unit asking one or more follow-up questions after receiving request to refine request and provide better search results, wherein said questions are based on at least industry specific knowledge, details of the services offered by available service providers at the moment and users answers to previous questions.

5. The method in claim 1, where filtering and shortlisting comprises:
refining search results using one or more among:
pre-defined rules;
intelligence gathered from request and subsequent questions asked to users previous history of similar search requests by the same user, users with similar profile or other users and patterns in final selection;
user session cookies;
recent interactions on the personal device by the user;
the number of leads pending to be served for relevant business services;
average review ratings for business services;
rate of booking appointments;
active promotions for relevant businesses;
geography of business services by matching consumers location proximity to a business's proximity if other conditions also match;
availability of business services at the time of request; and
availability of business services when the service is needed.

6. The method in claim 5, where said searching is performed on at least one among a pre-configured list of search engines and directory services.

7. The method in claim 1, where activating said guiding unit interface is done using one mechanism from the group of:
activating manually by the user by interacting with a visible artifact on a web page; and
activating automatically by the guiding unit, based on pre-defined rules.

8. The method in claim 7, where said artifact is one among:
page link;
a visible interactive widget on the web page; and
an invisible interactive widget activated by a voice command.

9. The method in claim 7, where said pre-defined rules include one or more among:
time elapsed since the time user landed on the interface;
detecting access of specific information on the interface; and
detecting an intent of user to access pre-defined type of information.

10. The method in claim 1, where said interactive session is one among:
voice call session;
chat session with a support member of the service; and
chat session with a chat-bot.

11. The method in claim 1, where said method further comprising:
performing, by the guiding unit, said one or more tasks through an interactive session.

12. The method in claim 11, where said one or tasks includes one or more among:
scheduling an appointment;
finding information about open hours; and
finding availability of a specific service.

13. The method in claim 1, where said method further comprising collecting data to train the guiding unit for improved guidance.

14. A system for guiding a user in choosing a service on a personal device, the system comprising:
a guiding unit for at least
identifying user action indicating a user need for connecting with businesses;
activating a personalized interactive interface to help user select a service provider;
engaging with user by asking one or more questions by the agent, and receiving answers from the user;
identifying list of services for the user to potentially connect with;
receiving, by the guiding unit, user confirmation to connect with a specified service; and
initiating, by the guiding unit, an interactive session between the user and the specified service, to enable the user to connect with the service;
a central server for at least
filtering and shortlisting said list of services using a filtering and prioritization module, when requested by the guiding unit to identify list of services for the user to potentially connect with, wherein the list of services is identified based on matching provider information available, business rules and user history.
